(19) United States
(12) Patent Application Publication
(10) Pub. No.: US 2010/0020000 A1
(43) Pub. Date: Jan. 28, 2010

(54) IMAGE OUTPUT DEVICE, PROJECTOR, AND CONTROL METHOD OF IMAGE OUTPUT DEVICE

(75) Inventor: Takahiro SAGAWA, Chino-shi (JP)

Correspondence Address: OLIFF & BERRIDGE, PLC, P.O. BOX 320850, ALEXANDRIA, VA, 22320-4850, US

(73) Assignee: Seiko Epson Corporation, Tokyo (JP)

(21) Appl. No.: 12/499,989

(22) Filed: Jul. 9, 2009

(30) Foreign Application Priority Data
Jul. 23, 2008 (JP) 2008-189567

(51) Int. Cl. G06F 3/038; G09G 3/36

(52) U.S. Cl. 345/90; 345/213

(57) ABSTRACT

An image output device which outputs an image signal to a liquid crystal display device dividing a screen by a plurality of channels to be operated by the plural channels, includes: a plurality of level controlling units provided for each of the channels to receive an image input signal from each of the channels, control the level of the image input signal, and output the controlled signal as the image signal to be outputted to the liquid crystal display device; a first reference signal supplying unit which supplies a first reference signal to the respective level controlling units in place of the image input signal in a predetermined period; and an adjustment correcting unit which compares output signals from the respective level controlling units with a second reference signal in the predetermined period and corrects corresponding adjustments of the level controlling units based on respective comparison results, wherein each of the level controlling units has a D/A converter which converts the image input signal as digital signal into an analog signal, and the adjustment correcting unit is provided in correspondence with the respective D/A converters and has a plurality of gain/offset correcting units each of which corrects at least either gain or offset of the corresponding D/A converter based on the comparison results.

### BACKGROUND

1. Technical Field

The present invention relates to a technology of outputting an image signal to a liquid crystal display device which divides a screen by a plurality of channels to be operated by the plural channels.

2. Related Art

A liquid crystal display containing a large number of pixels in the horizontal direction has a screen divided by a plurality of channels for operating by each of the channels, for example. According to an image output device connected with this type of liquid crystal display, the output levels of output circuits provided for the respective channels need to be equivalent so as to prevent unevenness in display.

JP-A5-150751 proposes a technology for achieving equivalence of the output levels. According to this technology, the levels of the output circuits can be adjusted for each channel. A reference signal is inputted to each of the output circuits, and outputs from the respective output circuits are compared with reference data prepared in advance. Then, level adjustments of the corresponding output circuits are corrected according to the comparison results.

According to this technology, however, each output level of the output circuits is adjusted when the image signal is analog information. Thus, each output circuit needs to have a signal correcting circuit exclusively used for correcting level adjustment. In this case, the overall circuit scale of the image output device increases.

### SUMMARY

It is an advantage of some aspects of the invention to provide a technology capable of simplifying the entire circuit structure of an image output device.

The invention can be realized as the following aspects or embodiments.

A first aspect of the invention is directed to an image output device which outputs an image signal to a liquid crystal display device dividing a screen by a plurality of channels to be operated by the plural channels including: a plurality of level controlling units provided for each of the channels to receive an image input signal from each of the channels, control the level of the image input signal, and output the controlled signal as the image signal to be outputted to the liquid crystal display device; a first reference signal supplying unit which supplies a first reference signal to the respective level controlling units in place of the image input signal in a predetermined period; and an adjustment correcting unit which compares output signals from the respective level controlling units with a second reference signal in the predetermined period and corrects corresponding adjustments of the level controlling units based on respective comparison results. Each of the level controlling units has a D/A converter which converts the image input signal as digital signal into an analog signal. The adjustment correcting unit is provided in correspondence with the respective D/A converters and has a plurality of gain/offset correcting units each of which corrects at least either gain or offset of the corresponding D/A converter based on the comparison results.

According to this structure, the first reference signal is supplied to the respective level controlling units in the predetermined period. The output signals from the respective level controlling units are compared with the second reference signal. The adjustments of the corresponding level controlling units are corrected based on the respective comparison results. Each of the level controlling units has the D/A converter. At least either gains or offsets of the respective D/A converters are corrected based on the comparison results to correct the adjustments. Since the level controlling units correct level adjustments by using the D/A converters prepared for converting digital image signals into analog signals, signal correcting circuit exclusively used for correcting level adjustment is not required. Thus, the overall circuit structure of the image output device can be simplified.

A second aspect of the invention is directed to the image output device of the first aspect, wherein each of the plural gain/offset correcting units corrects at least either upper limit reference voltage or lower limit reference voltage to be supplied to the corresponding D/A converter.

According to this structure, the level adjustments of the level controlling units can be corrected by the simple structure for correcting at least either the upper reference voltage or the lower reference voltage to be supplied to the D/A converters.

A third aspect of the invention is directed to the image output device of the second aspect, wherein each of the plural gain/offset correcting units includes: an up/down counter which performs addition or subtraction based on the comparison results; and a correcting D/A converter which converts an output value as digital signal from the up-down counter into an analog signal, and outputs the converted analog signal to the D/A converter as upper limit reference voltage or lower limit reference voltage.

According to this structure, each of the plural gain/offset correcting units has a simple structure constituted by the combination of the up/down counter and the correcting D/A converter. Thus, the overall circuit structure of the image output device can be further simplified.

A fourth aspect of the invention is directed to the image output device of the third aspect, wherein each of the plural correcting D/A converters is a ladder resistance type or integration type D/A converter.

According to this structure, each of the plural correcting D/A converters is a ladder resistance type or an integration type D/A converter. Thus, the structure of the correcting D/A converters can be simplified and provided as integrated circuit.

A fifth aspect of the invention is directed to the image output device of any of the first to fourth aspects, wherein each of the plural gain/offset correcting unit has a gain correcting unit and an offset correcting unit. The first reference signal supplying unit has a reference signal select output unit which selectively outputs black reference signal or white reference signal as the first reference signal. The adjustment correcting unit performs either offset control by the offset correcting unit or gain control by the gain correcting unit when a black reference signal is selected by the reference signal select output unit, and performs the other of the controls when a white reference signal is selected by the reference signal select output unit.

According to this structure, gain correction and offset correction of the D/A converters provided on the level controlling units can be performed by simple structure.

A sixth aspect of the invention is directed to the image output device of any of the first to fifth aspects, wherein the predetermined period is a preparation period from power ON, or at least either a first period contained in a preparation period before display start or a second period cyclically produced other than the two preparation periods.

According to this structure, correction of level adjustment can be performed at appropriate timing.

A seventh aspect of the invention is directed to the image output device of any of first to fifth aspects, wherein the predetermined period is a period contained in a vertical retrace line period.

According to this structure, correction of level adjustment can be performed without effecting display images corresponding to image signals.

An eighth aspect of the invention is directed to a projector including: the image output device of any of first to seventh aspects; and a liquid crystal display device connected with the image output device.

According to this structure, the projector can provide advantages described in the first to seventh aspects.

A ninth aspect of the invention is directed to a control method of an image output device which outputs an image signal to a liquid crystal display device having dividing a screen by a plurality of channels to be operated by the plural channels. The image output device includes a plurality of level controlling units provided for each of the channels to receive an image input signal from each of the channels, control the level of the image input signal, and output the controlled signal as the image signal to be outputted to the liquid crystal display device. Each of the level controlling units has a D/A converter which converts the image input signal as digital signal into an analog signal. A first reference signal is supplied to the D/A converters in place of the image input signal in a predetermined period. Output signals from the respective D/A converters are compared with a second reference signal, and at least either corresponding gains or offsets of the D/A converters are corrected based on respective comparison results.

The control method of the image output device can correct level adjustment by simple structure performing operations similar to those of the image output device.

The invention can be practiced in various forms such as an image output system, a computer program for providing functions of the image output device, a recording medium storing the computer program, and data signals containing the computer program and provided on carrier waves.

### BRIEF DESCRIPTION OF THE DRAWINGS

The invention will be described with reference to the accompanying drawings, wherein like numbers reference like elements.

FIG. 1 is a circuit diagram showing an image output device according to an embodiment of the invention.

FIG. 2 is a circuit diagram showing a liquid crystal display connected with the image output device.

FIG. 3 is a flowchart showing adjustment correcting process performed by an adjustment control unit of the image output device.

FIG. 4 is a timing chart showing changes of signals inside the image output device.

### DESCRIPTION OF EXEMPLARY EMBODIMENT

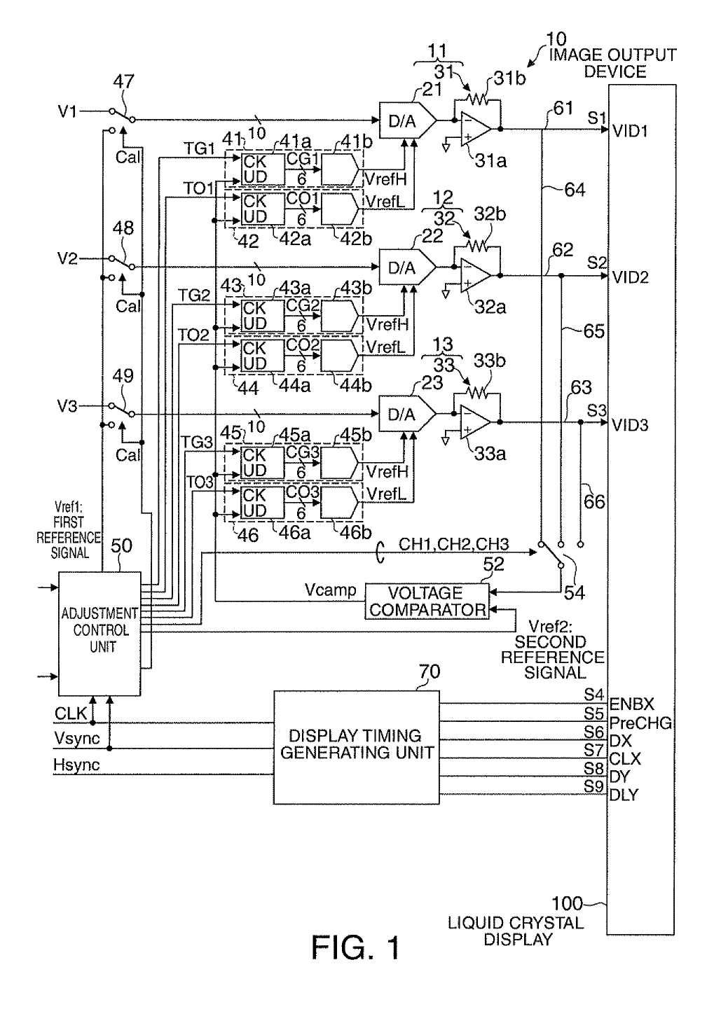

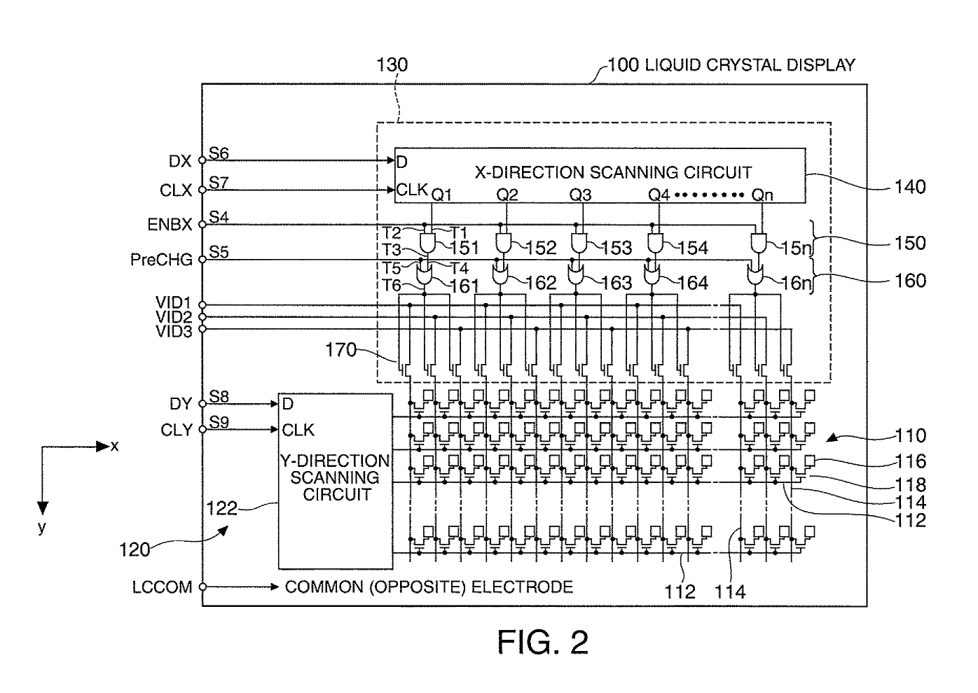

An exemplary embodiment according to the invention is hereinafter described. FIG. 1 is a circuit diagram showing a structure of an image output device 10 according to an embodiment of the invention. FIG. 2 is a circuit diagram showing a liquid crystal display 100 as a liquid crystal display device connected with the image output device 10. The details of the liquid crystal display 100 are initially described.

### A. STRUCTURE OF LIQUID CRYSTAL DISPLAY

The liquid crystal display 100 operates by active matrix drive system. As illustrated in FIG. 2, the liquid crystal display 100 includes a liquid crystal panel 110 for providing image display, a scanning line drive circuit 120 for driving the liquid crystal panel 110, and a signal line drive circuit 130 also for driving the liquid crystal panel 110.

The liquid crystal panel 110 has an array substrate (not shown). A plurality of scanning lines 112 extending in X direction (hereinafter referred to as “horizontal direction” as well), and a plurality of signal lines 114 extending in Y direction (hereinafter referred to as “vertical direction” as well) are disposed in matrix on the array substrate. Pixel electrodes (pixel patterns) 116 constituted by transparent electrodes and thin film transistors (TFT) 118 as switching elements are provided at the cross points of the scanning lines 112 and the signal lines 114, Gate electrodes of the TFT 118 are connected with the scanning lines 112, source electrodes of the TFT 118 are connected with the signal lines 114, and drain electrodes of the TFT 118 are connected with the pixel electrodes 116. This structure provides an active matrix unit containing the scanning lines 112, the signal lines 114, the pixel electrodes 116, and the TFT 118 on the substrate.

Though not shown in the figure, the liquid crystal panel 110 has an opposed substrate which includes opposed electrodes disposed opposed to the array substrate, and has liquid crystal material between the array substrate and the opposed substrate via orientation film.

The scanning line drive circuit 120 has a Y-direction scanning circuit 122. The Y-direction scanning circuit 122 is connected with the respective scanning lines 112 of the liquid crystal panel 110. The Y-direction scanning circuit 122 receives a vertical start signal S8 and a vertical clock signal S9 sent from the outside of the liquid crystal display 100 and scans the active matrix unit in the vertical direction according to the vertical start signal S8 and the vertical clock signal S9 to sequentially select the scanning lines 112.

The signal line drive circuit 130 is connected with the respective signal lines 114 of the liquid crystal panel 110. The signal line drive circuit 130 has an x-direction scanning circuit 140, an enable control unit 150, and a pre-charge drive circuit 160.

The X-direction scanning circuit 140 receives a horizontal start signal S6 and a horizontal clock signal S7 sent from the outside of the liquid crystal display 100 and scans the active matrix unit in the horizontal direction according to the horizontal start signal S6 and the horizontal clock signal S7 to sequentially select the signal lines 114.

The enable control unit 150 is constituted by n (n: positive plural number) AND circuits 151, 152, and up to 15n. First input pins T1 of the respective AND circuits 151 through 15n are connected with n output pins Q1, Q2, and up to Qn of the X-direction scanning circuit 140. Second input pins T2 of the respective AND circuits 151 through 15n are joined by one line to be connected with an enable signal pin ENBX as one connection pin of the liquid crystal display 100. Output pins T3 of the respective AND circuits 151 through 15n are connected with an OR circuit of the pre-charge drive circuit 160 described below.

The pre-charge drive circuit 160 has n OR circuits 161, 162, and up to 16n. First input pins T4 of the respective OR circuits 161 through 16n are connected with the output pins T3 of the AND circuits 151 through 15n. Second input pins T5 of the respective OR circuits 161 through 16n are joined by one line to be connected with a pre-charge timing signal pin PreCHG as one connection pin of the liquid crystal display 100.

Each output pin T6 of the OR circuits 161 through 16n is branched into three lines each of which is connected with TFT 170, more particularly, the gate electrode of the TFT 170 equivalent to the switching element provided on the liquid crystal panel 110. The TFT 170 is referred to as “scanning TFT” to be distinguished from the TFT 118 provided on the liquid crystal panel 110. The TFT 118 disposed on the liquid crystal panel 110 is referred to as “pixel TFT”. The scanning TFT 170 corresponds to “connection line continuity switch”.

The drain electrodes of the scanning TFT 170 are connected with the respective signal lines 114 of the liquid crystal panel 110. Thus, the number of the scanning TFT 170 is equal to the number of the signal lines 114. Since the number of the scanning TFT 170 is 3×n, the number of the signal lines 114 is also 3×n. Thus, n is equal to ⅓ of the number of the signal lines. That is, n is ⅓ of the number of the signal lines so as to drive ⅓ parts of the liquid crystal panel 110 divided in the horizontal direction.

The scanning TFT 170 in each group connected with the same OR circuit of the OR circuits 161 through 16n is divided into first channel scanning TFT, second channel scanning TFT, and third channel scanning TFT. The respective scanning TFT for each of the same channels in the respective groups are joined by one line, and the respective lines for the same channels in the respective groups are connected with analog image pins VID1, VID2, and VID3 of the liquid crystal display 100.

According to the liquid crystal display 100 having this structure, the Y-direction scanning circuit 120 selects the scanning lines 112, and the X-direction scanning circuit 140 selects the signal lines 114. In this case, electric signals transmitted from the analog vide pins VID1, VID2, and VID3 can be supplied to the desired pixel TFT 118. As a result, only the liquid crystal in the area sandwiched between the pixel electrode and the opposed electrode corresponding to the desired pixel TFT 118 on the liquid crystal display 100 changes the orientation by receiving electric field between the electrodes to function as liquid crystal shutter for each pixel. Furthermore, the liquid crystal display 100 can provided effective output signals from the respective output pins Q1, Q2, and up to Qn of the X-direction scanning circuit 140 by receiving the horizontal write enable signal S4 from the enable signal pin ENBX. Also, the liquid crystal display 100 can apply pre-charge voltage to the respective signal lines 114 in pre-charge period determined by the pre-charge timing signal S5 by receiving the pre-charge timing signal S5 from the pre-charge timing signal pin PreCHG.

### STRUCTURE OF IMAGE OUTPUT SIGNAL

As illustrated in FIG. 1, the image output device 10 is connected with the liquid crystal display 100. The image output device 10 transmits image signals by using three channels of first channel (channel 1), second channel (channel 2), and third channel (channel 3), and provides desired amplification on image signals for three channels outputted from an image processing circuit (not shown). The image signals for three channels are hereinafter referred to as first through third digital image input signals V1, V2, and V3.

The first through third digital image input signals V1, V2, and V3 are converted into analog signals by D/A converters 21, 22, and 23, and amplified by predetermined magnification using amplifiers 31, 32, and 33. That is, level controlling units 11, 12, and 13 for controlling input level are constituted by the D/A converters 21, 22 and 23 and the amplifiers 31, 32, and 33 for the respective channels.

The amplifiers 31, 32, and 33 have operation amplifiers 31a, 32a, and 33a and resistors 31b, 32b, and 33b, respectively. The magnifications of the respective amplifiers 31, 32, and 33 are equal according to the standard. Output signals S1, S2, and S3 from the amplifiers 31, 32, and 33 are inputted to the analog image pins VID1, VID2, and VID3 of the liquid crystal display 100 as analog image output signals for the respective channels. The orders of “first”, “second”, and “third” are added to the “level controlling unit”, “D/A converter”, “amplifier”, “output signal”, and “analog image pin” when channels to which these components belong need to be clarified.

The magnifications of the amplifiers 31, 32, and 33 are equal according to the standard as discussed above. Strictly speaking, however, these magnifications differ according to individual amplifiers or surrounding temperatures. For correcting differences thus produced, the D/A converters 21, 22, and 23 have gain correcting units 41, 43, and 45 for correcting gains of the D/A converters 21, 22, and 23, and offset correcting units 42, 44, and 46 for correcting offsets of the D/A converters 21, 22, and 23.

The gain correcting units 41, 43, and 45 determine upper limit reference voltage VrefH to be outputted to the D/A converters 21, 22, and 23. The offset correcting units 42, 44, and 46 determine lower limit reference voltage VrefL to be outputted to the D/A converters 21, 22, and 23. The D/A converters 21, 22, and 23 having received the upper limit reference voltage VrefH and the lower limit reference voltage VrefL can control the output by resolution corresponding to the bit number of the inputted digital signal in the range from the upper reference voltage VrefH to the lower limit reference voltage VrefL.

The gain correcting units 41, 43, and 45 and the offset correcting units 42, 44, and 46 have the same structure including up/down counters 41a through 46a, R-2R ladder resistance type D/A converters 41b through 46b.

Each of the up/down counters 41a through 46a has a clock pin CK and an up/down pin UD for commanding count-up or count-down. When a pulse signal is inputted to the clock pin CK with a low signal (L) commanding count-down inputted to the up/down pin UD, each of the up/down counters 41a through 46a outputs a value obtained by subtracting 1 from the current count number. When a pulse signal is inputted to the clock pin CK with a high signal (H) commanding count-up inputted to the up/down pin UD, each of the up/down counters 41a through 46a outputs a value obtained by adding 1 to the current count number.

The R-2R ladder resistance type D/A converters 41b through 46b are known converters containing resistances of R and resistances of 2R disposed in a ladder shape, and convert digital signals indicating count numbers outputted from the up/down counters 41a through 46a into analog signals. The output signals from the respective R-2R ladder resistance type D/A converters 41b through 46b, that is, the converted analog signals are sent to the D/A converters 21, 22, and 23.

That is, the gain correcting units 41, 43, and 45 can output analog signals corresponding to count numbers outputted from the up/down counters 41a, 43a, and 45a provided on the gain correcting units 41, 43, and 45 to the D/A converters 21, 22, and 23 as the upper reference voltage VrefH. The offset correcting units 42, 44, and 46 can output analog signals corresponding to count numbers outputted from the up/down counters 42a, 44a, and 46a provided on the offset correcting units 42, 44, and 46 to the D/A converters 21, 22, and 23 as the lower limit reference voltage VrefL.

Input select switches 47, 48, and 49 are provided before the respective D/A converters 21, 22, and 23. The input select switches 47, 48, and 49 switch between a first condition for sending the first through third digital image input signals V1, V2, and V3 to the D/A converters 21, 22, and 23 and a second condition for sending a first reference signal Vref1 instead of the digital image input signals V1, V2, and V3 to the D/A converters 21, 22, and 23. More specifically, the input select switches 47, 48, and 49 receive an adjustment correction mode signal Cal and select the first condition based on the judgment as image display mode when the adjustment correction mode signal Cal is low level, and select the second condition based on the judgment as adjustment correction mode when the adjustment correction mode signal Cal is high level. The first reference signal Vref1 is supplied from an adjustment control unit 50 to the respective input select switches 47 through 49.

The adjustment control unit 50 outputs the adjustment correction mode signal Cal to the respective input select switches 47 through 49. The adjustment control unit 50 also outputs control signals TG1, TG2, and TG3 determining the correction timing to the gain correcting units 41, 43, and 45, and further outputs control signals TO1, TO2, and TO3 determining correction timing to the offset correcting units 42, 44, and 46. The adjustment control unit 50 further outputs a second reference signal Vref2 to a voltage comparator 52 described later. More specifically, the adjustment control unit 50 outputs the control signals TG1, TG2, and TG3 to the clock pins CK of the updown counters 41a, 43a, and 45a of the gain correcting units 41, 43, and 45, and outputs the control signals TO1, TO2, and TO3 to the clock pins CK of the up/down counters 42a, 44a, and 46a of the offset correcting units 42, 44, and 46.

The adjustment control unit 50 is constituted by a so-called microcomputer or a logic circuit, and receives the clock signal CLK and a vertical synchronous signal Vsync to control the gain correcting units 41, 43, and 45 and the offset correcting units 42, 44, and 46. The adjustment correcting process performed by the adjustment control unit 50 will be described later.

Branch lines 64, 65, and 66 are connected with connection lines 61, 62, and 63 connecting between the amplifiers 31, 32, and 33 and the analog image pins VID1, VID2, and V1D3. The other ends of the branch lines 64, 65, and 66 are connected with an output select switch 54. The output select switch 54 is electrically connected with the voltage comparator 52, and selects one of the output signals S1, S2, and S3 received from the amplifiers 31, 32, and 33 to send the selected signal to the voltage comparator 52. The output select switch 54 receives a first channel command CH1 corresponding to the channel 1, a second channel command CH2 corresponding to the channel 2, and a third channel command CH3 corresponding to the channel 3 from the adjustment control unit 50, and selects the output signals S1, S2, and S3 based on the commands CH1 through CH3. More specifically, the output select switch 54 selects the first output signal S1 when the first channel command CH1 is high level, selects the second output signal S2 when the second channel command CH2 is high level, and selects the third output signal S3 when the third channel command CH3 is high level.

The voltage comparator 52 compares the output signals S1, S2, and S3 sent from the output select switch 54 with the second reference signal Vref2 sent from the adjustment control unit 50 to judge which of these signals has higher voltage. The voltage comparator 52 outputs a comparison result signal Vcomp indicating which voltage is higher as the judgment result to the gain correcting units 41, 43, and 45 and the offset correcting units 42, 44, and 46 of the D/A converters 21, 22, and 23. More specifically, the voltage comparator 52 outputs “L” when S1, S2, and S3 (output signals)≧Vref2 (second reference signal), and outputs “H” when S1, S2, and S3 (output signals)<Vref2 (second reference signal). The voltage comparator 52 outputs these signals to the up/down pins UD of the up/down counters 41a, 43a, and 45a of the gain correcting units 41, 43, and 45 and the up/down pins UD of the up/down counters 42a, 44a, and 46a of the offset correcting units 42, 44, and 46.

When S1, S2, and S3 (output signals)≧Vref2 (second reference signal), the signal “L” is inputted to the up/down counters 41a, 43a, and 45a of the gain correcting units 41, 43, and 45. Thus, 1 is subtracted from the count numbers outputted from the up/down counters 41a, 43a, and 45a. When S1, S2, and S3 (output signals)<Vref2 (second reference signal), the signal “H” is inputted to the up/down counters 41a, 43a, and 45a of the gain correcting units 41, 43, and 45. Thus, 1 is added to the count numbers outputted from the up/down counters 41a, 43a, and 45a. Accordingly, the gain correcting units 41, 43, and 45 determine that the correction direction is decreasing direction and lower the upper reference voltage VrefH by 1 step when S1, S2, and S3≧Vref2, and determine that the correction direction is increasing direction and raise the upper reference voltage VrefH by 1 step when S1, S2, and S3<Vref2.

When S1, S2, and S3 (output signals)≧Vref2 (second reference signal), the signal “L” is inputted to the up/down counters 42a, 44a, and 46a of the offset correcting units 42, 44, and 46. Thus, 1 is subtracted from the count numbers outputted from the up/down counters 42a, 44a, and 46a. When S1, S2, and S3 (output signals)<Vref2 (second reference signal) the signal “H” is inputted to the up/down counters 42a, 44a, and 46a of the offset correcting units 42, 44, and 46. Thus, 1 is added to the count numbers outputted from the up/down counters 42a, 44a, and 46a. Accordingly, the offset correcting units 42, 44, and 46 determine that the correction direction is decreasing direction and lower the lower reference voltage VrefL by 1 step when S1, S2, and S3≧Vref2, and determine that the correction direction is increasing direction and raise the lower reference voltage VrefL by 1 step when S1, S2, and S3<Vref2.

The image output device 10 further includes a display timing generating unit 70. The display timing generating unit 70 has a known structure, and is not explained in detail herein. The display timing generating unit 70 generates the horizontal write enable signal S4, the precharge timing signal S5, the horizontal start signal S6, the horizontal clock signal S7, the vertical start signal S8, and the vertical clock signal S9 based on the clock signal CLK, the vertical synchronous signal Vsync, and the horizontal synchronous signal Hsync, and outputs these signals S4 through S9 to the liquid crystal display 100.

### ADJUSTMENT CORRECTING PROCESS

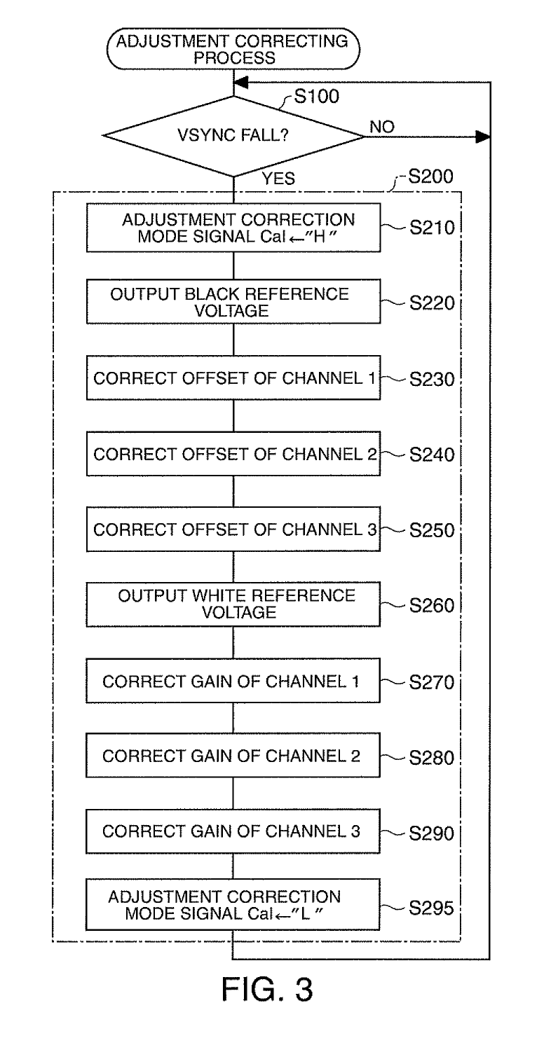

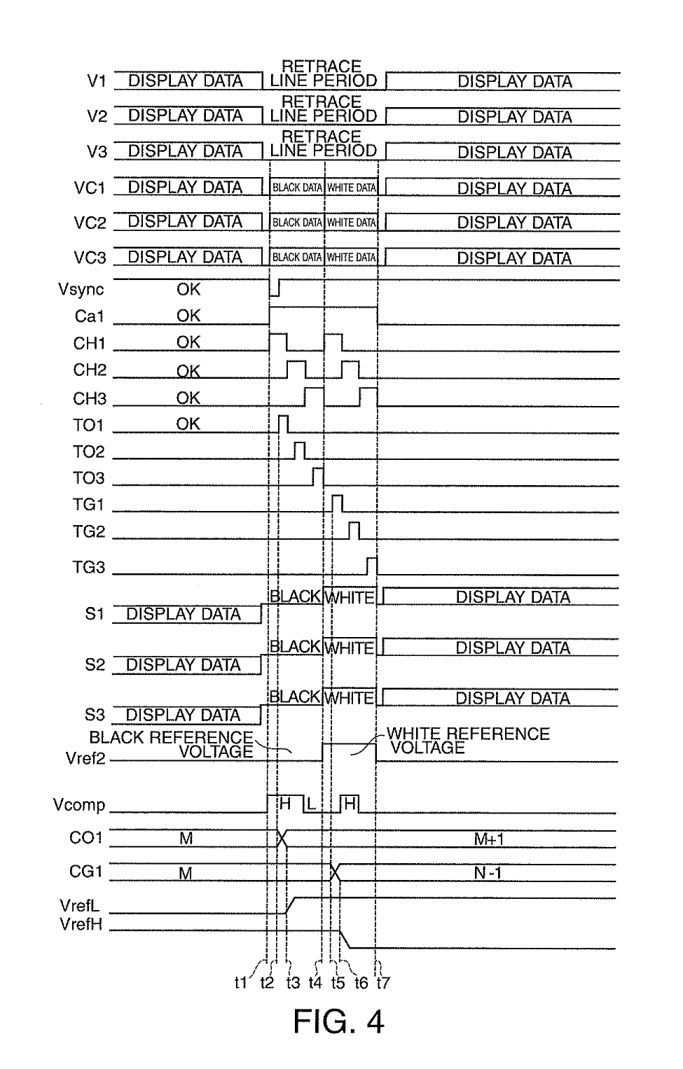

The adjustment correcting process performed by the adjustment control unit 50 of the image output device 10 is now discussed. FIG. 3 is a flowchart showing the adjustment correcting process, and FIG. 4 is a timing chart showing changes of signals inside the image output device 10. The steps performed in the adjustment correcting process are sequentially explained with reference to the flowchart in FIG. 3, and changes of the signals are discussed with reference to FIG. 4 as necessary. As described above, the adjustment correcting process is performed by the microcomputer (or logic circuit) constituting the adjustment control unit 50. The adjustment correcting process is initiated when the power source of the image output device 10 is switched from OFF condition to ON condition.

As shown in FIG. 3, the CPU as microcomputer judges whether the current condition is at the falling time of the vertical synchronous signal Vsync or not at the start of the process (step S100). When it is judged that the current condition is not at the falling time, the process returns to the start. When it is judged that the current condition is at the falling time (time t1 in FIG. 4), adjustment correction mode process is initiated (step S200)

In the adjustment correction mode process in step S200, the CPU outputs the adjustment correction mode signal Cal as high level (step S210) r outputs black reference voltage as the first reference signal Vref1 (step S220), and performs process for correcting offset of the channel 1 (step S230).

When the adjustment correction mode signal Cal becomes high level by step S210, the input select switches 47, 48, and 49 select the second condition for sending the first reference signal Vref1 to the D/A converters 21, 22, and 23. It can be seen from the timing chart in FIG. 4 that the adjustment correction mode signal Cal is high level at time t1.

After the input select switches 47, 48, and 49 are switched to the condition for selecting the first reference signal Vref1 by step S210, black reference voltage is outputted in step S220. As a result, digital input signals VC1, VC2, and VC3 outputted from the D/A converters 21, 22, and 23 become black reference voltage, i.e., black data as shown in FIG. 4.

The following steps i) through iii) are specifically performed in the process for correcting offset of the channel 1 in step S230.

i) Setting the first channel command CH1 corresponding to the channel 1 to be sent to the output select switch 54 at high level to switch the output select switch 54 to the condition for selecting the first output signal S1.

ii) Outputting the second reference signal Vref2 corresponding to the black reference voltage outputted in step S220 to the voltage comparator 52.

iii) Outputting the timing signal TO1 to the offset correcting unit 42 provided on the first D/A converter 21 corresponding to the channel 1.

After the black reference voltage is applied to the first D/A converter 21 in step S220, the steps i) and ii) are performed. Then, the voltage comparator 52 compares the first output signal S1 (see FIG. 4) as the output from the first amplifier 31 obtained when the black reference voltage is applied and the second reference signal Vref2 corresponding to the equivalent color reference voltage. When the first output signal S1 is smaller than the second reference signal Vref2, the signal “H” is outputted from the voltage comparator 52 to the offset correcting unit 42 (time t1 in FIG. 4). When the step iii) is executed, the up/down counter 42a of the offset correcting unit 42 adds 1 to a counter number CO1 at the time when the timing signal TO1 is outputted (time t2 in FIG. 4). More specifically, the up/down counter 42a changes the counter number CO1 from M (M: positive number) to M+1 as time t3 in FIG. 4. As a result, offset can be raised by 1 step by increasing the lower limit reference voltage VrefL of the first D/A converter 21 by 1 step. When the first output signal S1 is equal to or larger than the second reference signal Vref2, offset of the first D/A converter 21 can be lowered by 1 step using the offset correcting unit 42.

The first output signal S1 outputted from the amplifier 31 when black reference voltage is applied corresponds to the offset of the level controlling unit 11. Thus, the offset of the first level controlling unit 11 corresponding to the channel 1 can be close to the offset determined by the second reference signal Vref2 by increasing or decreasing the offset by predetermined correction such that the difference between the first output signal S1 and the second reference signal Vref2 calculated by comparison between these signals can be reduced.

After the process in step S230 ends, the CPU initiates the process for correcting offset of the channel 2 (step S240). This process corresponds to the process in step S230 for the channel 2, and the following steps iv) through vi) are specifically performed.

iv) Setting the second channel command CH2 corresponding to the channel 2 to be sent to the output select switch 54 at high level to switch the output select switch 54 to the condition for selecting the second output signal S2.

v) Outputting the second reference signal Vref2 corresponding to the black reference voltage outputted in step S220 to the voltage comparator 52.

vi) Outputting the timing signal TO2 to the offset correcting unit 44 provided on the second D/A converter 22 corresponding to the channel 2.

By the process in step S240, the offset of the second level controlling unit 12 corresponding to the channel 2 can be close to the offset determined by the second reference signal Vref2. Then, the CPU initiates the process for correcting offset of the channel 3 (step S250). This process corresponds to the process in step S230 for the channel 3, and steps similar to those for the channel 1 and the channel 2 are performed. Thus, the same explanation is not repeated herein. By the process in step S250, the offset of the third level controlling unit 13 corresponding to the channel 3 can be close to the offset determined by the second reference signal Vref2. By repeating the adjustment correction mode in step S200, the respective offsets of the first through third level controlling units 11 through 13 corresponding to the channels 1, 2, and 3 gradually and precisely come close to the offset of the reference signal Vref2.

The end time of step S250 corresponds to the central time (time t4) in the retrace line period (vertical retrace line period) as shown in FIG. 4. Returning to FIG. 3, the CPU outputs white reference voltage as the first reference signal Vref1 (step S260) after performing the process in step S250 to correct the gain of the channel 1 (step S270). The following steps vii) through x) are specifically performed in the process for correcting the gain of the channel 1 in step S270.

vii) Setting the first channel command CH1 corresponding to the channel 1 to be sent to the output select switch 54 at high level to switch the output select switch 54 to the condition for selecting the first output signal S1.

ix) Outputting the second reference signal Vref2 corresponding to the white reference voltage outputted in step S260 to the voltage comparator 52.

x) Outputting the timing signal TG1 to the gain correcting unit 41 provided on the first D/A converter 21 corresponding to the channel 1.

After the white reference voltage is applied to the first D/A converter 21 in step S260, the steps vii) through x) are performed. Then, the voltage comparator 52 compares the first output signal S1 (see FIG. 4) as the output from the first amplifier 31 obtained when the white reference voltage (white data; see FIG. 4) is applied and the second reference signal Vref2 corresponding to the equivalent color reference voltage. When the first output signal S1 is equal to or larger than the second reference signal Vref2, the signal “L” is outputted from the voltage comparator 52 to the gain correcting unit 41 (time t4 in FIG. 4). When the step x) is executed, the up/down counter 41a of the gain correcting unit 41 subtracts 1 from a counter number CG1 at the time when the timing signal TG1 is outputted (time t5 in FIG. 4). More specifically, the up/down counter 41a changes the counter number CG1 from N (N: positive number) to N−1 as time t6 in FIG. 4. As a result, offset can be lowered by 1 step by decreasing the upper limit reference voltage VrefH of the first D/A converter 21 by 1 step. As a result, gain can be decreased by 1 step by decreasing the upper limit reference voltage VrefH of the first D/A converter 21 by 1 step. When the first output signal S1 is smaller than the second reference signal Vref2, the gain of the first D/A converter 21 can be increased by 1 step using the gain correcting unit 41.

The output signal S1 outputted from the amplifier 31 when white reference voltage is applied is associated with the gain of the level controlling unit 11. Thus, the gain of the first level controlling unit 11 corresponding to the channel 1 can be close to the gain determined by the second reference signal Vref2 by increasing or decreasing the gain by predetermined correction such that the difference between the first output signal S1 and the second reference signal Vref2 calculated by comparison between these signals can be reduced.

After the process in step S270 ends, the CPU initiates the process for correcting gain of the channel 2 (step S280). This process corresponds to the process in step S270 for the channel 2, and the following steps xi) through xiii) are specifically performed.

xi) Setting the second channel command CH2 corresponding to the channel 2 to be sent to the output select switch 54 at high level to switch the output select switch 54 to the condition for selecting the second output signal S2.

xii) Outputting the second reference signal Vref2 corresponding to the white reference voltage outputted in step S260 to the voltage comparator 52.

xiii) Outputting the timing signal TG2 to the gain correcting unit 43 provided on the second D/A converter 22 corresponding to the channel 2.

By the process in step S280, the gain of the second level controlling unit 12 corresponding to the channel 2 can be close to the gain determined by the second reference signal Vref2. Then, the CPU initiates the process for correcting gain of the channel 3 (step S290). This process corresponds to the process in step S270 for the channel 3, and steps similar to those for the channel 1 and the channel 2 are performed. Thus, the same explanation is not repeated herein. By the process in step S290, the gain of the third level controlling unit 13 corresponding to the channel 3 can be close to the gain determined by the second reference signal Vref2. By repeating the adjustment correction mode in step S200, the respective gains of the first through third level controlling units 11 through 13 corresponding to the channels 1, 2, and 3 gradually and precisely come close to the gain of the reference signal Vref2.

After the process in step S290 performs, the CPU sets the adjustment correction mode signal Cal at low level (step S295). The time for setting low level corresponds to time t7 as shown in FIG. 4, which is positioned immediately before the end of the vertical retrace line period. When the adjustment correction mode signal Cal becomes low level, the input select switches 47, 48, and 49 are switched to the first condition for sending the first through third digital image input signals V1, V2, and V3 to the level controlling units 11 through 13. As a result, the mode is changed to image display mode. After the process in step S295 ends, that is, after the adjustment correction mode in step S200 is completed, the process returns to step S100 to repeat the process in the main routine.

According to the image output device 10, the input select switches 47, 48, and 49 and the adjustment control unit 50 constitute a “first reference signal supplying unit” in the appended claims. Also, the voltage comparator 52, the gain correcting units 41, 43, and 45, the offset correcting units 42, 44, and 46, and the adjustment control unit 50 constitute an “adjustment correcting unit” in the appended claims.

### D. ADVANTAGES

The image output device 10 having this structure supplies the first reference signal Vref1 to the level controlling units 11 through 13 for the respective channels in the adjustment correction mode which sets the vertical retrace line period as the adjustment correction mode period, and compares the output signals from the level controlling units 11 through 13 with the second reference signal Vref2 to correct the adjustments of the corresponding level controlling units 11 through 13 based on the comparison results. In the image output device 10, each of the level controlling units 11 through 13 further includes the D/A converters 21 through 23, and corrects the gains and offsets of the D/A converters 21 through 23 based on the comparison results to correct the adjustments. Since the level controlling units 11 through 13 correct level adjustments by using the D/A converters 21 through 23 prepared for converting digital image signals into analog signals, signal correcting circuit exclusively used for correcting level adjustment is not required. Thus, the overall circuit structure of the image output device 10 can be simplified.

According to this embodiment, the gain correcting units 41, 43, and 45 and the offset correcting units 42, 44, and 46 have simple structures constituted by the combinations of the up/down counters 41a through 46a and the R-2R ladder resistance type D/A converters 41b through 46b. Thus, the overall circuit structure of the image output device 10 can be further simplified.

According to this embodiment, the period of the adjustment correction mode is determined within the vertical retrace line period. Thus, the level adjustment can be corrected without effecting display images corresponding to image signals. Also, gain correction and offset correction of the D/A converters 21 through 23 can be easily achieved by selectively switching between black reference signals and white reference signals as the first reference signal Vref1 to be supplied to the level controlling units 11 through 13.

### E. MODIFIED EXAMPLE

The invention is not limited to the embodiments described herein, but may be practiced otherwise without departing from the scope and spirit of the invention. For example, the following modifications may be made.

### E1. Modified Example 1

According to the embodiment, the screen of the liquid crystal display 100 is divided by three to be operated by three channels. However, the number of channels is not limited to three but may be other plural numbers such as 2, 6, and 12. In this case, the image output device includes the same number of level controlling units as that of channels. The direction of dividing the liquid crystal display may be vertical direction of the screen instead of the horizontal direction.

### E2. Modified Example 2

According to the embodiment, the period of the adjustment correction mode, i.e., a “predetermined period” in the appended claims is the vertical retrace line period. However, the adjustment correction mode period may be the preparation period from the power source ON, or a period contained in the preparation period before display start. Alternatively, the adjustment correction mode period may be a period cyclically produced instead of the vertical retrace line period such as horizontal retrace line period. While the period for the adjustment correction mode is substantially equal to the vertical retrace line period in the embodiment, the period for the adjustment correction mode may be a part of the vertical retrace line period instead of the entire vertical retrace line period.

### E3. Modified Example 3

According to the embodiment, adjustment for controlling the input signal level is corrected by controlling gains and offsets of the D/A converters 21 through 23. However, only either the gains or offsets may be controlled. In the embodiment, adjustments of the corresponding level controlling units 11 through 13 are increased or decreased by predetermined correction such that the difference between the output signals from the level controlling units 11 through 13 when the first reference signal Vref1 is supplied and the second reference signal Vref2 calculated by comparison can be reduced. However, gains and offsets may be increased or decreased by correction varied according to the difference obtained by the same comparison.

### E4. Modified Example 4

According to this embodiment, the gain correcting units 41, 43, and 45 and the offset correcting units 42, 44, and 46 have the up-down counters 41a through 46a and the R-2R ladder resistance type D/A converters 41b through 46b. However, for example, the R-2R ladder resistance type D/A converters 41b through 46b may be D/A converters of other types such as binary resistance type D/A converters and integration type D/A converters. That is, the gain correcting units 41, 43, and 45 and the offset correcting units 42, 44, and 46 may have any structures as long as the upper limit reference voltage or the lower limit reference voltage applied to the D/A converters 21 through 23 can be corrected based on the comparison results of the voltage comparator 52. The gain correcting units and the offset correcting units are not limited to the structures correcting the upper limit reference voltage and the lower limit reference voltage to be applied to the D/A converters, but may correct the gains and offsets of the D/A converters by other methods.

### E5. Modified Example 5

The invention is not limited to the system including the image output device 10 and the liquid crystal display 100, but may be applicable to a projector. More specifically, a projector which has the liquid crystal display 100 as a liquid crystal panel equipped as an element of the projector, and contains the image output device 10 as a built-in device of the projector may be provided as an example of the invention.

A part of the structure provided by hardware according to this embodiment may be provided by software, and a part of the structure provided by software may be provided by hardware.

The entire disclosure of Japanese Patent Application No. 2008-189567, filed July 23 is expressly incorporated by reference herein.

What is claimed is:

1. An image output device which outputs an image signal to a liquid crystal display device dividing a screen by a plurality of channels to be operated by the plural channels, the method comprising:
a plurality of level controlling units provided for each of the channels to receive an image input signal from each of the channels, control the level of the image input signal, and output the controlled signal as the image signal to be outputted to the liquid crystal display device;
a first reference signal supplying unit which supplies a first reference signal to the respective level controlling units in place of the image input signal in a predetermined period; and
an adjustment correcting unit which compares output signals from the respective level controlling units with a second reference signal in the predetermined period and corrects corresponding adjustments of the level controlling units based on respective comparison results,
wherein
each of the level controlling units has a D/A converter which converts the image input signal as digital signal into an analog signal, and
the adjustment correcting unit is provided in correspondence with the respective D/A converters and has a plurality of gain/offset correcting units each of which corrects at least either gain or offset of the corresponding D/A converter based on the comparison results.

2. The image output device according to claim 1, wherein each of the plural gain/offset correcting units corrects at least either upper limit reference voltage or lower limit reference voltage to be supplied to the corresponding D/A converter.

3. The image output device according to claim 2, wherein each of the plural gain/offset correcting units includes:
an up/down counter which performs addition or subtraction based on the comparison results; and
a correcting D/A converter which converts an output value as digital signal from the up-down counter into an analog signal, and outputs the converted analog signal to the D/A converter as upper limit reference voltage or lower limit reference voltage.

4. The image output device according to claim 3, wherein each of the plural correcting D/A converters is a ladder resistance type or integration type D/A converter.

5. The image output device according to claim 1, wherein:
each of the plural gain/offset correcting units has a gain correcting unit and an offset correcting unit;
the first reference signal supplying unit has a reference signal select output unit which selectively outputs black reference signal or white reference signal as the first reference signal; and
the adjustment correcting unit performs either offset control by the offset correcting unit or gain control by the gain correcting unit when a black reference signal is selected by the reference signal select output unit, and performs the other of the controls when a white reference signal is selected by the reference signal select output unit.

6. The image output apparatus according to claim 1, wherein the predetermined period is at least one of a first period included in a preparation period after a power supply is turned on or a preparation period before display starts and a second period that is periodically generated other than both the preparation periods.

7. The image output device according to claim 1, wherein the predetermined period is a period contained in a vertical retrace line period.

8. A projector comprising:
the image output device according to claim 1; and
a liquid crystal display device connected with the image output device.

9. A control method of an image output device which outputs an image signal to a liquid crystal display device dividing a screen by a plurality of channels to be operated by the plural channels, wherein:
the image output device includes a plurality of level controlling units provided for each of the channels to receive an image input signal from each of the channels, control the level of the image input signal, and output the controlled signal as the image signal to be outputted to the liquid crystal display device;
each of the level controlling units has a D/A converter which converts the image input signal as digital signal into an analog signal;
a first reference signal is supplied to the D/A converters in place of the image input signal in a predetermined period; and
output signals from the respective D/A converters are compared with a second reference signal, and at least either corresponding gains or offsets of the D/A converters are corrected based on respective comparison results.
